(19) United States
(12) Patent Application Publication
(10) Pub. No.: US 2007/0264294 A1
(43) Pub. Date: Nov. 15, 2007

(54) INSECT CONTROL COMPOSITIONS

(76) Inventors: Edward T. Lance-Gomez, Racine, WI (US); Anne T. Maghasi, Racine, WI (US); John S. Nelson, Watersmeet, MI (US)

Correspondence Address: S.C. JOHNSON & SON, INC., 1525 HOWE STREET, RACINE, WI, 53403-2236, US

(21) Appl. No.: 11/382,574

(22) Filed: May 10, 2006

(51) Int. Cl. A01N 25/00

(52) U.S. Cl. 424/405

(57) ABSTRACT

Disclosed herein are sprayable insect repellent compositions that provide improved skin feel through the incorporation of a powder ingredient. The powder is essentially permanently suspended in the composition by a thickener (e.g. carbomer thickener) so that no shaking to resuspend settled out powder is necessary immediately before the composition is applied to the skin. This is achieved in an aerosol or spritz spray formulation, while avoiding clogging problems. One composition contains ethanol, DEET or picaridin, carbomer thickener, a neutralizer, corn starch powder, water, and gas propellant.

### CROSS-REFERENCE TO RELATED APPLICATIONS

Not applicable.

### STATEMENT REGARDING FEDERALLY SPONSORED RESEARCH/DEVELOPMENT

Not applicable.

### BACKGROUND OF THE INVENTION

The present invention relates to insect control compositions, particularly insect repellent compositions, that can be applied to human skin. In particular, the invention relates to sprayable insect repellents that contain a powder for improving skin feel. Furthermore, the invention relates to means for so suspending such a powder in a primarily aqueous formulation, optionally together with other liquids or materials not soluble in water, in such a way that the mixture does not readily phase separate, allowing the delivery of all the formulation's ingredients in their proper concentrations without the need for a user's remixing them just prior to delivery.

A variety of insect repellent compositions designed to be applied to the skin have previously been proposed. For example, U.S. Pat. No. 4,774,082 discloses use of N,N-diethyl-m-toluamide (“DEET”) as a preferred repellent that can be delivered in a spray form, such as in an aerosol spray, by using hydrocarbon propellants. U.S. Pat. No. 6,719,959 discloses that repellents such as picaridin (or DEET) can be delivered via an aerosol spray or spritz, using materials such as hydrocarbon propellant, water, ethanol, isododecane, and thickeners in the delivery formulation.

It is also known that an insect repellent can be delivered in the form of a gel or otherwise thickened liquid, including where the thickener is a carbomer. See e.g., U.S. Pat. Nos. 6,441,034 and 6,646,011.

As carbomers are typically acidic, a carbomer is preferably used in connection with a neutralizer such as triethanolamine. See also the BF Goodrich web site describing use of AMP-95 as a neutralizer for its Carbopol® brand thickeners.

Powders such as silica powders and corn starch powders have been proposed to be included in aerosol compositions for a variety of reasons. For example, including a powder in such a spray improves skin feel when the composition is sprayed onto the skin. There have even been suggestions to mix such powders with insect repelling compositions. See generally U.S. Pat. No. 6,581,807.

However, powders included in sprayable formulations tend to settle out, thus requiring a user to shake the container before each spray (or risk having formulations with different powder content as the product is used up). Regardless of whether consumers remember to shake the container before use, requiring such shaking often also leads to some consumer dissatisfaction. Complicating matters is that if such powders are incorporated into sprays the overall formulation may lead to clogging of the spray nozzle if poorly dispersed powder is directed through the nozzle.

Accordingly, a need exists for improved, powder-containing, insect control formulations that avoid the need for shaking the formulation immediately prior to use, while also avoiding significant clogging problems, optionally together with the stable distribution of other beneficial ingredients not soluble in water.

### BRIEF SUMMARY OF THE INVENTION

The present invention provides insect repellent compositions that provide improved skin feet, such as a dry, non-greasy/non-oily skin feel. There is provided a powder ingredient where the powder is essentially permanently suspended in the composition so that no shaking to resuspend settled out powder is necessary immediately before the composition is applied to the skin.

In one form the invention provides a sprayable insect control composition. There is a liquid carrier, an insect control ingredient, a powder, and a thickener. The thickener is present in a sufficient amount so as to suspend the powder in the carriers yet not so high an amount so as to prevent the composition from being sprayed.

Highly preferred liquid carriers include water and a short chain monohydric alcohol such as ethanol. The insect control ingredient is preferably a repellent, but may also be an insecticide and/or an insect growth regulator, depending on how the composition is to be used.

Preferred thickeners are gelling thickeners capable of shear thinning when, for example, being delivered via a spray nozzle. Preferably the thickeners are capable of forming a thixotropic gel. Most preferably the thickeners are carbomer thickeners.

A variety of potentially useful thickeners are from the class referred to as “associative thickeners”. Many have a hydrophilic polymeric compound with substitution of hydrophobic chains along the polymer backbone. The polymer is then soluble in water but the hydrophobic groups self-associate across polymer backbones to form a network structure in solution. This forms a gel which can be shear thinned because the hydrophobic associations are readily broken. Thus, other thickeners of this nature are potential thickeners for use in the present invention.

When the thickener is too acidic for the proposed use absent neutralization, it is desirable to control the pH with a neutralizer.

Particularly preferred ingredient ranges are:

(a) 5% by weight to 60% by weight water;

(b) 0% by weight to 50% by weight alcohol;

(c) 0% by weight to 65% by weight hydrocarbon;

(d) 1% by weight to 20% by weight insect control ingredient;

(e) 0.5% by weight to 25% by weight of powder; and

(f) 0.05% by weight to 1% by weight of thickener.

When the composition is in a form of an aerosol spray, a propellant gas is also included. Particularly preferred propellant gasses are selected from the group consisting of hydrocarbon gasses, hydrofluorocarbon gasses, and chlorofluorocarbon gasses. For example, the gasses may be mixtures of ethane, propane, butane, isobutane, pentane, isopentane, or a subset thereof.

The composition may also include a fragrance, and/or other skin care ingredients of interest. For example, sunscreen, waterproofing, emollient, or other chemicals of interest for treating the skin may be included where otherwise compatible with the core ingredients.

In another form the invention provides a canister capable of delivering an aerosolized spray of insect repellent. The canister has a housing having an internal cavity containing an insect repellent composition, and a control valve for delivering the repellent from the cavity to a selected site. The composition includes a liquid carrier, an insect control ingredient, a gas propellant, a powder, and a thickener. The thickener is present in a sufficient amount so as to suspend the powder in the carrier, yet not so high an amount so as to prevent the composition from being sprayed through the control valve.

In yet another form the invention provides a method for repelling insects from human skin. One sprays such a composition onto the skin.

The inventors have discovered that water acts with their thickeners to form a gel structure to suspend the powder. They have further learned that their other proposed ingredients do not destroy the gel structure.

It will be appreciated that the present invention provides insect repellent compositions with good skin feel and little risk of clogging the spray dispenser. These and still other advantages of the present invention will be apparent from the description below.

### DETAILED DESCRIPTION OF THE PREFERRED EMBODIMENTS

There are provided insect control compositions that contain water, an organic solvent (preferably ethanol, optionally also with isododecane or other skin feel affecting organic solvents), an insect control ingredient (preferably a repellent active and more preferably DEET or picaridin), a powder (preferably corn starch), a thickener (preferably a carbomer), optionally a neutralizer (preferably triethanolamine or 2-amino-2-methyl-1-propanol), and, when the formula is an aerosol spray, a gas propellant (preferably a hydrocarbon gas).

The composition may further contain fragrances, colorants, other suspended solids or materials not completely dissolved in the water and organic solvent, and other compatible materials. The powder ingredient provides an improved skin feel and the thickener ingredient serves the function of essentially permanently suspending the powder in the composition via a gel structure so that no shaking to resuspend settled out powder is necessary immediately before the composition is applied to the skin. Preferably the gel is thixotropic. Surprisingly, the gel structure does not clog standard spritz pump or aerosol spray valves.

For the purpose of the present invention, “insect” means not only flying insects, but also crawling insects. It also includes as well spiders, millipedes, and other arthropods commonly controlled in essentially the same manner or with the same agents as are commonly used to control insects pests.

“Insect repellent” means any chemical that prevents or discourages insects from contacting a treated site (e.g. human skin treated with an effective amount of the repellent), or remaining close to a treated site. The particular insects that are repelled by the composition of the invention will depend upon the insect repellent active material selected. While some insect repellent active materials may be specific to a particular insect species, other active materials may broadly repel a variety of insects.

Among repellents that can be employed are N,N diethyl-m-toluamide (“DEET”), hydroxy-ethyl isobutyl piperidine carboxylate (1-piperidinecarboxylic acid or picaridin, Bayer KBR 3023), ethyl butylacetylaminopropionate (IR3535 by Merck Co.), 2-ethyl-1,3-hexanediol, oil of citronella, soy bean oil, lemon grass oil, geranium/geraniol oil, p-menthane-3,8-diol, and mixtures thereof. Other actives that can be used in the present invention are disclosed in U.S. Pat. Nos. 5,130,136 and 5,698,209. In some preferred embodiments the amount of the one or more insect repellent actives is from about 1% to about 20%, preferably from about 2% to about 17%, and more preferably from about 2% to about 15% by weight based on the total weight of the composition.

Water used in the present invention may be for example purified water, deionized water, or the like. The amount of water included in the composition of the invention may be from about 5% to about 60%, preferably from about 10% to about 55%, and more preferably from about 10% to about 50% by weight based on the total weight of the composition.

While any suitable organic solvent may be used in the composition of the invention, alcohols are preferred. Preferred alcohols are represented by the formula R—OH wherein R is a hydrocarbon chain of 1 to 8, most preferably 1 to 6. The hydrocarbon chain can be saturated, unsaturated, linear, branched, cyclic, or polycyclic and can have substituted groups including those with heteroatoms (atoms other than carbon and hydrogen).

Isododecane is another preferred ingredient in the composition of the invention when a quickly evaporating alcohol or other solvent is used. Isododecane provides an improved skin feel when the composition is, for example, a topical insect repellent. In this context, isododecane is a solvent of reduced volatility, compared to an alcohol of the chain length referred to above. Similar, alternative solvents or organic liquids can be used, when otherwise suitable for topical application. Examples include C₁₀ to C₂₀ saturated hydrocarbons with or without monomethyl branching, C₁₀ to C₂₀ alkylated benzoates, and low molecular weight silicone fluids with or without substitution on the backbone.

The amount of total organic solvents included in the composition of the invention (apart from propellant gas) is preferably from about 15% to about 65%, more preferably from about 20% to about 60%, and most preferably from about 25% to about 57% by weight based on the total weight of the composition.

The powders used in the composition of the invention may be those for improving skin feel, such as providing a dry feel, when composition is applied to the skin. For example, starch, silicas, talcs, micas, clays and other inorganic materials traditionally used to deliver a dry feel to the skin may be used in the invention. In addition or in alternative, the powder may provide other functions such as holding the repellent active to the skin to maintain its effect or acting as an active. Other examples of powders that may be used in connection with the present invention include but are not limited to chlorohydroxyalminium, tolnaphthate, ridocain, chlorohexizine gluconnate, kaolin, sericite, magnesium carbonate, calcium carbonate, magnesium silicate, aluminum silicate, magnesium aluminate metasilicate, zeolite, calcium sulfate, hydroxyapatite, ceramic powder, boron nitride, molybdenum disulfide, polyamide resin powder, polyethylene powder, polystyrene powder, poly(methyl methacrylate) powder, cellulose powder, silicone resin powder, titanium dioxide, iron oxide, pyrite, titanium oxide, carbon black, ultramarine, aluminum powder, copper powder, and an active component powder. See generally U.S. Pat. No. 6,581,807.

In one embodiment, one or more starch powders such as corn, barley, tapioca, or wheat powders are used in the present invention. By “starch,” we mean a polymer of glucose linked by α(1-4) linkages to give linear chains, which are joined by α(1-6) linkages resulting in branches in the polymer. Normal starch contains about 75% amylopectin, a highly-branched molecule, and 25% of amylose, a primarily linear molecule. These polymers are organized into an insoluble granule within cereal seeds. Starch granules are highly organized, containing of a series of concentric spheres with alternating crystalline and amorphous regions. These may also be chemically-modified starches.

Corn starch powder is a preferred powder for the purposes of the present invention. The total amount of one or more powders that may be included in the composition of the invention is preferably from about 0.5% to about 25%, more preferably from about 1% to about 20%, and most preferably from about 1% to about 15% by weight based on the total weight of the composition.

While a thickener that is sufficiently thick to keep the powder permanently suspended in the composition yet is capable of shearing can be used in the present invention, preferred thickeners are the carbomers. “Carbomers” are thickening polymers of acrylic acid, methacrylic acid, or salts thereof, that are cross-linked. This cross-linking can be with a polyfunctional compound such as polyalkenyl ethers of sugars or of polyalcohols (e.g., allyl ether of sucrose, allyl ether of pentaeythritol, or allyl ether of propylene). Carbomers are especially useful in a spray composition of the invention because they thin sufficiently under shear force, e.g., when sprayed, so as not to clog the sprayer during the spray. In one embodiment, homopolymers or copolymers of acrylic acid or salts thereof cross-linked with an allyl ether of pentaeythritol, an allyl ether of sucrose, or an allyl ether of propylene are used in the present invention. An exemplary carbomer useful in the compositions of the invention is a copolymer of C₁₀₋₃₀ alkyl acrylates and one or more monomers of acrylic acid, methacrylic acid or one of their simple esters cross-linked with an allyl ether of sucrose or an allyl ether of pentaerythritol.

Specific examples of carbomers useful in the present invention include the products sold under the name Carbopol® (BF Goodrich, Ohio, USA) such as Carbopol 934, Carbopol 940, Carbopol 941, Carbopol 971, Carbopol 974, Carbopol EZ2, Carbopol ETD 2001, Carbopol ETD 2020, Carbopol ETD 2050, Carbopol ultrez 10, Carbopol ultrez 20, or Carbopol ultrez 21. The total amount of one or more such thickeners that may be included in the composition of the invention is preferably from about 0.05% to about 1%, more preferably from about 0.1% to about 0.5%, and most preferably from about 0.15% to about 0.4% by weight based on the total weight of the composition.

If a thickener is too acidic (or too basic) for the desired application (e.g. on human skin) it can be neutralized to a desired pH range around the neutral pH of 7.0. For example, the composition may have a pH in the range of about 5.0 to about 9.0, preferably from about 6.0 to about 8.0, and more preferably from about 6.5 to about 7.5.

Carbomers are acidic and they can be neutralized with either organic or inorganic bases. Exemplary organic and inorganic bases include 2-amino-2-methyl-1-propanol 95% (AMP-95), triethanolamine, tris(hydroxymethyl)amino methane (tromethamine), tetrahydroxypropyl ethylenediamine, PEG-15 cocamine, diisopropanolamine, triisopropanolamine, arginine, ammonium hydroxide, sodium hydroxide, and potassium hydroxide. The total amount of one or more gel thickener neutralizers that may be included in a composition of the invention is preferably from about 0.05% to about 1%, more preferably from about 0.1% to about 0.5%, and most preferably from about 0.15% to about 0.4% by weight based on the total weight of the composition.

The compositions of the invention are designed to be sprayed, such as in an aerosol spray or a pump spritz spray. When they are used as an aerosol spray there will be a gas propellant (e.g., hydrocarbons, hydrofluorocarbons, chlorofluorocarbons, or a mixture thereof) provided in the spray composition. An exemplary insect repellent aerosol spray of the invention contains an amount of water ranging from about 10% to about 50% by weight of the total weight of the composition, an amount of one or more organic solvents ranging from about 25% to about 57% by weight of the total weight of the composition, an amount of one or more repellent actives ranging from about 1% to about 20% by weight of the total weight of the composition, an amount of one or more powders ranging from about 1% to about 15% by weight of the total weight of the composition, an amount of one or more gel thickeners ranging from about 0.1% to about 0.5% by weight of the total weight of the composition, an amount of one or more gel thickener neutralizers ranging from about 0.1% to about 0.5% by weight of the total weight of the composition, and an amount of a propellant gas ranging from about 5% to about 15% by weight of the total weight of the composition.

The spray may also be a pump spritz spray. An exemplary insect repellent pump spritz spray of the invention contains an amount of water ranging from about 25% to about 55% by weight of the total weight of the composition, an amount of one or more organic solvents ranging from about 20% to about 60% by weight of the total weight of the composition, an amount of one or more repellent actives ranging from about 1% to about 20% by weight of the total weight of the composition, an amount of one or more powders ranging from about 1% to about 20% by weight of the total weight of the composition, an amount of one or more gel thickeners ranging from about 0.1% to about 0.4% by weight of the total weight of the composition, and optionally an amount of one or more gel thickener neutralizers ranging from about 0.1% to about 0.4% by weight of the total weight of the composition.

The order of mixing the spray components is not critical, albeit mixing the powder in should be done in a way so as to minimize lump formation. Propellant gas can be added in a conventional manner.

By way of example, but not limitation, examples of the present invention are provided below in the following eight sets of examples:

### EXAMPLE 1

### Nine Examples of Insect Repellent Aerosol Spray Compositions (1-9) of the Invention are Provided as Follows

| | 1 | 2 | 3 | 4 | 5 | 6 | 7 | 8 | 9 |
|---|---|---|---|---|---|---|---|---|---|
| | % wt. | % wt. | % wt. | % wt | % wt. | % wt. | % wt. | % wt. | % wt |
| water | 25.00 | 45.00 | 35.00 | 35.00 | 45.00 | 25.00 | 25.00 | 35.00 | 45.00 |
| ethanol | 50.62 | 30.62 | 43.12 | 45.62 | 35.62 | 55.62 | 53.12 | 40.62 | 33.12 |
| DEET | 7.00 | 7.00 | 7.00 | 7.00 | 7.00 | 7.00 | 7.00 | 7.00 | 7.00 |
| corn starch | 7.00 | 7.00 | 4.50 | 2.00 | 2.00 | 2.00 | 4.50 | 7.00 | 4.50 |
| Carbopol | 0.20 | 0.20 | 0.20 | 0.20 | 0.20 | 0.20 | 0.20 | 0.20 | 0.20 |
| ETD 2020 | | | | | | | | | |
| AMP-95 | 0.18 | 0.18 | 0.18 | 0.18 | 0.18 | 0.18 | 0.18 | 0.18 | 0.18 |
| hydrocarbon | 10.00 | 10.00 | 10.00 | 10.00 | 10.00 | 10.00 | 10.00 | 10.00 | 10.00 |
| propellant | | | | | | | | | |

### EXAMPLE 2

### Nine More Aerosol Examples with the Same Ingredients Except for a Different Neutralizer

| | 1 | 2 | 3 | 4 | 5 | 6 | 7 | 8 | 9 |
|---|---|---|---|---|---|---|---|---|---|
| | % wt. | % wt | % wt. | % wt. | % wt. | % wt. | % wt | % wt | % wt |
| water | 45.00 | 25.00 | 35.00 | 35.00 | 45.00 | 25.00 | 25.00 | 35.00 | 45.00 |
| ethanol | 30.50 | 50.50 | 43.00 | 45.50 | 35.50 | 55.50 | 53.00 | 40.50 | 33.00 |
| DEET | 7.00 | 7.00 | 7.00 | 7.00 | 7.00 | 7.00 | 7.00 | 7.00 | 7.00 |
| corn starch | 7.00 | 7.00 | 4.50 | 2.00 | 2.00 | 2.00 | 4.50 | 7.00 | 4.50 |
| Carbopol | 0.20 | 0.20 | 0.20 | 0.20 | 0.20 | 0.20 | 0.20 | 0.20 | 0.20 |
| ETD 2020 | | | | | | | | | |
| TEA | 0.30 | 0.30 | 0.30 | 0.30 | 0.30 | 0.30 | 0.30 | 0.30 | 0.30 |
| hydrocarbon | 10.00 | 10.00 | 10.00 | 10.00 | 10.00 | 10.00 | 10.00 | 10.00 | 10.00 |
| propellant | | | | | | | | | |

### EXAMPLE 3

### Three More Aerosol Examples with the Same Ingredients as Example 1 Except for a Different Active

| | 1 (% by | 2 (% by | 3 (% by |
|---|---|---|---|
| | weight) | weight) | weight) |
| water | 25.00 | 35.00 | 20.00% |
| ethanol | 39.43 | 29.62 | 44.62 |
| p-menthane-3,8-diol | 15.00 | 15.00 | 15.00 |
| corn starch | 10.00 | 10.00 | 10.00 |
| Carbopol ETD 2020 | 0.30 | 0.20 | 0.20 |
| AMP-95 | 0.27 | 0.18 | 0.18 |
| hydrocarbon propellant | 10.00 | 10.00 | 10.00 |

### EXAMPLE 4

### Three More Aerosol Examples

| | 1 (% by | 2 (% by | 3 (% by |
|---|---|---|---|
| | weight) | weight) | weight) |
| water | 30.00 | 41.42 | 25.00 |
| ethyl alcohol | 39.42 | 28.00 | 49.42 |
| picardin | 10.33 | 10.33 | 10.33 |
| corn starch | 10.00 | 10.00 | 5.00 |
| Carbopol ultrez 10, | 0.10 | 0.10 | 0.10 |
| Carbopol ultrez 21, or | | | |
| Carbopol ETD 2020 | | | |
| triethanolamine | 0.15 | 0.15 | 0.15 |
| hydrocarbon propellant | 10.00 | 10.00 | 10.00 |

### EXAMPLE 5

### Three Pump Spritz Examples

| | 1 (% by | 2 (% by | 3 (% by |
|---|---|---|---|
| | weight) | weight) | weight) |
| water | 36.83 | 44.45 | 35.00 |
| ethanol | 37.62 | 30.00 | 49.45 |
| picardin | 5.17 | 5.17 | 5.17 |
| corn starch | 5.00 | 5.00 | 5.00 |
| Carbopol | 0.20 | 0.20 | 0.20 |
| ETD 2020 | | | |
| AMP-95 | 0.18 | 0.18 | 0.18 |
| isododecane | 15.00 | 15.00 | 5.00 |

### EXAMPLE 6

### Two More Pump Spritz Examples, Albeit with a Different Active

| | 1 (% by | 2 (% by |
|---|---|---|
| | weight) | weight) |
| water | 50.00 | 35.00 |
| ethanol | 37.62 | 37.43 |
| ethyl | 7.00 | 7.00 |
| butylacetylaminopropionate | | |
| corn starch | 5.00 | 5.00 |
| Carbopol ETD 2020 | 0.20 | 0.30 |
| AMP-95 | 0.18 | 0.27 |
| isododecane | 0.00 | 15.00 |

### EXAMPLE 7

### Two More Pump Spritz Examples

| | 1 (% by | 2 (% by |
|---|---|---|
| | weight) | weight) |
| water | 35.00 | 35.00 |
| ethanol | 50.62 | 22.62 |
| DEET | 2.00 | 15.00 |
| corn starch | 2.00 | 12.00 |
| Carbopol ETD 2020 | 0.20 | 0.20 |
| AMP-95 | 0.18 | 0.18 |
| isododecane | 10.00 | 15.00 |

### EXAMPLE 8

### Two More Pump Spritz Examples

| | 1 (% by | 2 (% by |
|---|---|---|
| | weight) | weight) |
| water | 50.00 | 35.00 |
| ethanol | 37.62 | 37.43 |
| p-menthane-3,8-diol | 7.00 | 7.00 |
| corn starch | 5.00 | 5.00 |
| Carbopol ETD 2020 | 0.20 | 0.30 |
| AMP-95 | 0.18 | 0.27 |
| isododecane | 0.00 | 15.00 |

The nature of the dispenser is not critical. One aerosol dispenser that is designed for delivering a powdered spray is disclosed in U.S. Pat. No. 6,581,807, the disclosure of which is hereby incorporated by reference as if fully set forth herein. The base formulation and propellant gas of the present invention would be loaded into those dispensers in a conventional manner.

In the case of a spritz spray the formulation would be poured into a conventional pump spritz bottle. The nature of the pump spritz bottle is not critical, and a wide variety of conventional spritz bottles currently used to deliver DEET or other insecticidal formulations could be used.

In the most preferred manner the sprayer would be held about six inches from human skin and the spray then applied to that skin. This could, for example, provide mosquito repellency.

While preferred embodiments of the present invention have been described and otherwise disclosed herein, alternative embodiments are also intended to be within the scope of the claims. Thus, the invention is not to be judged solely by the preferred embodiments. Rather, the claims should be looked to in order to judge the full scope of the invention.

### INDUSTRIAL APPLICABILITY

The invention provides sprayable insect control compositions which do not require shaking immediately prior to dispensing, notwithstanding the presence of powders in the compositions which provide skin feel benefit.

We claim:

1. A sprayable insect control composition, comprising:
a liquid carrier;
an insect control ingredient;
a powder; and
a thickener,
wherein the thickener is present in a sufficient amount so as to suspend the powder in the carrier, yet not so high an amount so as to prevent the composition from being sprayed.

2. The composition of claim 1, wherein the carrier comprises water and an organic solvent, and the insect control ingredient is an insect repellent.

3. The composition of claim 1 wherein the powder is a starch powder.

4. The composition of claim 1, wherein the thickener is a carbomer thickener.

5. The composition of claim 4, further comprising a neutralizer selected from the group consisting of 2-amino-2-methyl-1-propanol, triethanolamine, tetrahydroxypropyl ethylenediamine, tromethamine, PEG-15 cocamine, diisopropanolamine, triisopropanolamine, arginine, ammonium hydroxide, sodium hydroxide, and potassium hydroxide.

6. The composition of claim 1, wherein the composition comprises:
(a) 5% by weight to 60% by weight water;
(b) 0% by weight to 50% by weight alcohol;
(c) 0% by weight to 65% by weight hydrocarbon;
(d) 1% by weight to 20% by weight insect control ingredient;
(e) 0.5% by weight to 25% by weight of powder; and
(f) 0.05% by weight to 1% by weight of thickener.

7. The composition of claim 1, wherein the composition is in a form of an aerosol spray and the composition further comprises a propellant gas.

8. The composition of claim 7, wherein the propellant gas is selected from the group consisting of hydrocarbon gasses, hydrofluorocarbon gasses, and chlorofluorocarbon gasses.

9. The composition of claim 1, wherein the composition is in a form of a pumpable spritz spray.

10. The composition of claim 1, wherein the carrier comprises water and a monohydric alcohol having from 2 to 4 carbon atoms.

11. The composition of claim 1, wherein the insect control ingredient is selected from the group consisting of N,N-diethyl-m-toluamide, picardin, p-menthane-3,8-diol, and ethyl butylacetylaminopropionate.

12. The insect repellent composition of claim 1 further comprising a fragrance.

13. The insect repellent composition of claim 1 wherein the thickener forms a thixotropic gel.

14. A canister capable of delivering an aerosolized spray of insect repellent, said canister comprising:
a housing having an internal cavity containing an insect repellent composition; and
a control valve for delivering the repellent from the cavity to a selected site;
wherein the composition comprises:
a liquid carrier;
an insect control ingredient;
a gas propellant;
a powder; and
a thickener,
and wherein the thickener is present in a sufficient amount so as to suspend the powder in the carrier yet not so high an amount so as to prevent the composition from being sprayed through the control valve.

15. A method for repelling insects from human skin comprising the step of spraying onto the skin a composition comprising:
a liquid carrier;
an insect control ingredient;
a powder; and
a thickener,
wherein the thickener is present in a sufficient amount so as to suspend the powder in the carrier, yet not so high an amount so as to prevent the composition from being sprayed.
